(19) United States
(12) Patent Application Publication
(10) Pub. No.: US 2024/0231301 A1
(43) Pub. Date: Jul. 11, 2024

(54) SAFETY NETWORK FOR DEVICES IN INTERMITTENT USE

(71) Applicant: ABB Schweiz AG, Baden (CH)

(72) Inventors: Zhibo Pang, Västerås (SE); Bjoern Matthias, Bad Schönborn, BW (DE)

(21) Appl. No.: 18/557,923

(22) PCT Filed: May 4, 2021
(86) PCT No.: PCT/EP2021/061654

§ 371 Date: Oct. 27, 2023

(51) Int. Cl. G05B 19/042

(52) U.S. Cl. CPC G05B 19/0428; G05B 2219/14012

(57) ABSTRACT

A safety network for supporting one or more devices in intermittent use, the safety network being susceptible of verification and/or validation as a safety loop and including a safety controller configured to
assess the integrity of the safety network, and
monitor safety sensors and cause safety actuators to respond to any detected safety events in accordance with safety rules.

The safety network implements safety representatives, each configured to
maintain a virtual representation of an associated device in intermittent use, including at least one virtual safety sensor and/or virtual safety actuator,
make the virtual representation available for integrity assessment and monitoring by the safety controller, and
perform wireless data synchronization between the virtual representation and the associated device.

The virtual representation further includes an activation indicator, which determines a safety rule for the safety controller's monitoring and/or for the safety representative's data synchronization.

### TECHNICAL FIELD

The present disclosure relates to the field of industrial automation and in particular to a safety network which is suitable for supporting devices in intermittent use.

### BACKGROUND

Functional safety is of primary concern in industrial automation systems. The safety design becomes more challenging as more and more mobile safety-related devices are introduced into automation systems, such as mobile robots, unmanned aerial vehicles (UAVs), unmanned ground vehicles (UGVs), safety helmets with smart sensors, safety suits with wearable sensing and monitoring capabilities, portable inspection and control devices etc. From the safety point of view, the behaviors of such mobile devices are “occasional” during the operational period of the safety system because
the devices can be activated or deactivated on demand,
the devices can join or leave the automation system dynamically, and
the physical distances between the devices and the concerned safety zones may change over time.
   In the following, such devices will be referred to as occasional behavior safety devices (OBSDs) to reflect their intermittent use, whether temporally or spatially or both.

With the relevant safety standards and regulations e.g. IEC 61508 [1], ISO 13849 [2] and ISO 11161 [3], the present-day static approach for verification and validation does not allow the safety functions of a system to be modified at runtime. Thus, OBSDs cannot be added or removed from safety networks with the desired flexibility that would match the functional flexibility.

The basic structure of a safety function in the area of safety of machinery, as discussed for example in ISO 13849-1 ([2] Part 1), is depicted in FIG. 1. Here, input signals 110 are processed by logic 112 that implements the safety function, which in turn leads to a dedicated output 114. The purpose of the output signals 114 is to influence the machinery in a manner that reduces risk as determined necessary by interpreting the input signals.

An example input signal 110 can be the output of a safety laser scanner. When a person or object enters the plane supervised by the scanner, a signal is passed to the logic 112. The function implemented there can decide to stop the machinery since a person may be at risk, having entered the supervised plane. The output signals 114 then serve to stop the machinery, e.g. by opening a safety relay that interrupts the supply of power to the actuators.

Today's safety standards generally do not allow an algorithm to change the geometry of the supervision field of the scanner at runtime. Such a change would require a renewed verification and validation of its correctness as well as a restart of the safety system; see [4] clause 6.3.9. Additional reference is made to [1] Part 3, Table A.2, which lists dynamic reconfiguration as “not recommended”. In other words, the logic block 112 of the safety function must remain unchanged. A workaround used in practice is to predefine a set of several fixed supervision-field geometries and to switch between these at runtime as ordered by safety signal inputs. Such field sets are verified and validated before starting productive operation. In an abstract sense, all the field sets are then simultaneously part of the logic block 112 of the safety function.

Thus, in general, it is presently not possible to add or remove OBSDs from localized safety networks, dedicated to risk reduction, e.g. at a particular machine, or to change their safety configurations in real time. As a result, convenient segmenting of the safety networks in a larger facility is not possible. Existing solutions for OBSDs have these integrated into static safety networks, which means the devices can neither join nor leave the safety network dynamically. Present-day safety networks supervise the constant presence of all components from the time of startup (integrity assessment). Any change in the topology of the safety networks will trigger a transition of the system into the safe state. The safe state of machinery may be defined as a state when there are no remaining unacceptable risks to operator personnel (see [1] IEC 61508-4, clauses 3.1.13 and 3.1.11). In practice, this usually means stopping machinery and interrupting productivity.

In essence, present-day safety functions of which mobile OBSDs can be a part are preconfigured to include all possible inputs and outputs, so as to cover all use cases in a static manner, without taking account of the actual location of the OBSD and the relevance or irrelevance of certain inputs and outputs for the risk reduction objective.

Static solutions do not scale well, since the number of devices to be scan-ned increases when the number of OBSDs increases, even though most such devices will not be relevant to the response to a given safety-related situation. Such static solutions also suffer from excessive down time because the transition to the safe state of any of the OBSDs will trigger the transition of the entire system into a safe state, when e.g. an OBSD is deactivated or activated, leaves or re-joins the system, or is too far away from the system and the communication link lapses. Therefore, a more efficient and scalable solution is needed to add, remove and reconfigure the OBSDs in safety critical automation systems, without breaching the existing safety standards and regulations.

The need to dynamically adapt safety systems is relevant in several neighboring technical domains. These include, for example, the area of automated driving, where presently the safety concepts for an automated vehicle cannot depend in an essential manner on the information from other vehicles or fixed stations in a dynamic manner [5]. This hurdle must be overcome for the development of functionally safe automated vehicles without the need for human intervention as a backup. Functions such as unmanned platooning, basically a system of systems, depend on safe coordination [6].

### SUMMARY

In view of the above preliminary discussion, it is an objective of the present disclosure to make available a safety network that allows the adding, removing and reconfiguration of devices in intermittent use (including OBSDs) without breaching existing safety standards and regulations. It is a further objective to provide a safety network that is fit for safety-critical and/or mission-critical automation systems. In the interest of scalability, it is a particular objective to be able to limit OBSDs' communication with other safety entities in a facility to only such information that is relevant to the evaluation of the momentary risk at the location and in the immediate environment of the OBSD. Furthermore, it is an objective to provide a method of operating a safety network so as to enable it to support devices in intermittent use.

At least some of these objectives are achieved by the invention as defined by the independent claims. The dependent claims relate to advantageous embodiments.

In a first aspect of the invention, there is provided a safety network for supporting one or more devices in intermittent use, such as OBSDs. The safety network is susceptible of verification and/or validation as a safety loop. Further, the safety network comprises a safety controller which is configured to assess the integrity of the safety network and to monitor safety sensors and cause safety actuators to respond to any detected safety events in accordance with safety rules. It is understood that the safety network may optionally include one or several local safety controllers, each responsible for a subset of safety sensors, safety rules and safety actuators; part of the safety controller's monitoring may then be executed by (e.g., delegated to) the local safety controllers.

In the present disclosure, the terms verification, validation and safety loop shall have the established ordinary meaning—or one of the established ordinary meanings—in the technical field concerned, as evidenced by the cited references. For example, verification may be related to a technical standard, norm, regulation or specification; validation for its part may refer to needs or desires of a user, owner or customer. If the safety network can be subjected to a repeatable test procedure, for which a positive conclusion of verification (validation) is a possible result, then the safety network is susceptible of verification (validation). If the test procedure is one targeting safety loops in the sense of [1] or other applicable references, then the safety network may be said to be susceptible of verification (validation) as a safety loop. In the terminology of the present disclosure, furthermore, an integrity assessment of a safety network may comprise the execution of a test procedure to confirm that the safety network is complete and functioning. The safety network may be considered complete if all nominal components are present; it is functioning if none of the components is defective or inoperable.

According to the first aspect of the invention, further, the safety network implements one or more safety representatives, and each safety representative is configured to maintain a virtual representation of an associated device in intermittent use (e.g., to emulate the associated device), to make the virtual representation available for integrity assessment and monitoring by the safety controller, and to perform wireless data synchronization between the virtual representation and the associated device. The virtual representation includes at least one virtual safety sensor or at least one virtual safety actuator or both of these. The virtual representation further includes an at least two-valued activation indicator, which determines a safety rule for the safety controller's monitoring and/or for the safety representative's data synchronization.

The positive or negative value of the activation indicator may, in various embodiments, modify whether the virtual safety sensor shall be included in monitoring by the safety controller (or its delegate local safety controller, if any); how detected safety events shall be responded to; whether data synchronization between the virtual representation and the associated device shall be performed; whether the associated device shall execute any data related to the virtual safety actuators; whether risk-inducing functionalities of the associated device shall be disabled; the value of a communication watchdog timer of the associated device; whether clock synchronization between the virtual representation and the associated device shall be performed and what tolerance shall apply. In contrast, the virtual representation may remain included in the safety controller's integrity assessment regardless of the value of the activation indicator. Compared to available safety networks, where intermittently used devices might have to be excluded from the integrity assessment—or the integrity assessment may have to be disabled altogether—this aspect contributes to safer and more robust operation.

Another advantage is that this aspect decouples the design of the safety network and the design of the OBSDs. Indeed, if the OBSDs are a mobile robot system, the mobile robot manufacturer will only need to make a safety representative available to the developer of the safety network. Design, implementation and certification of the safety representative and of the OBSDs can therefore be conducted separately. The system integration step, in which these components are then combined, will not need additional risk assessment, verification or validation unless new hazards are introduced by the integration itself. There are many use cases where system integration does not contribute new hazards. For example, to deploy multiple mobile robots in a manufacturing process, the fleet management system of the mobile robots needs to be integrated with the manufacturing execution system, the other machines, the process control system and the safety network in the facility. If all the operational conditions are already covered during the safety design and validation of every element of the integrated manufacturing process, such as the mobile robots, fleet management system, manufacturing execution system, the other machines, the process control system and the safety network, then there is no need to re-do the safety validation for the integrated manufacturing process.

In a second aspect of the invention, there is provided a safety representative implemented in a safety network for supporting one or more devices in intermittent use. The safety representative is configured to: maintain a virtual representation of an associated one of said devices in intermittent use, the virtual representation including at least one virtual safety sensor and/or at least one virtual safety actuator; make the virtual representation available for integrity assessment and monitoring by a safety controller of the safety network; and perform wireless data synchronization between the virtual representation and the associated device. According to the second aspect, further, the safety representative is configured to maintain, in the virtual representation, an at least two-valued activation indicator, which determines a safety rule the for the safety representative's data synchronization.

In a third aspect of the invention, there is provided a method of operating a safety network for supporting one or more devices in intermittent use. The method comprises: repeatedly assessing the integrity of the safety network; repeatedly monitoring a plurality of safety sensors to detect safety events; responding to any detected safety events using a plurality of safety actuators and in accordance with safety rules; and making the safety network available for verification and/or validation as a safety loop. The method further comprises maintaining a virtual representation of an associated one of said devices in intermittent use; making the virtual representation available for said integrity assessment and monitoring; and performing wireless data synchronization between the virtual representation and the associated device. The virtual representation includes at least one virtual safety sensor, at least one virtual safety actuator, or both. It further includes an at least two-valued activation indicator, which determines a safety rule for said monitoring and/or said data synchronization.

The second and third aspects of the invention generally share the effects and advantages of the first aspect, and they can be implemented with an equal degree of technical variation.

The invention further relates to a computer program containing instructions for causing a computer—or one or more entities in the safety network in particular—to carry out the above method. The computer program may be stored or distributed on a data carrier. As used herein, a “data carrier” may be a transitory data carrier, such as modulated electromagnetic or optical waves, or a non-transitory data carrier. Non-transitory data carriers include volatile and non-volatile memories, such as permanent and non-permanent storage media of magnetic, optical or solid-state type. Still within the scope of “data carrier”, such memories may be fixedly mounted or portable.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

Aspects and embodiments are now described, by way of example, with reference to the accompanying drawings, on which:

FIG. 1 shows a basic structure of a safety function in the area of safety of machinery;

FIG. 2 illustrates a system architecture of a safety network which supports multiple devices in intermittent use;

FIG. 3 shows a safety representative and an associated device in intermittent use;

FIG. 4 is a flowchart of a method for operating a safety network; and

FIG. 5 shows mobile robots coordinated by a fleet management system to perform material handling tasks.

### DETAILED DESCRIPTION

The aspects of the present disclosure will now be described more fully hereinafter with reference to the accompanying drawings, in which certain embodiments of the invention are shown. These aspects may, however, be embodied in many different forms and should not be construed as limiting; rather, these embodiments are provided by way of example so that this disclosure will be thorough and complete, and to fully convey the scope of all aspects of the invention to those skilled in the art. Like numbers refer to like elements throughout the description.

FIG. 2 shows a safety network 200 and six associated devices 290 in intermittent use, which may be OBSDs. The safety network 200 or at least a portion thereof constitutes a safety loop 210 which is susceptible of verification and/or validation; in particular, the safety loop 210 can be subjected to a repeatable test procedure, for which a positive conclusion of verification and/or validation is a possible result. In FIG. 2, the safety loop 210 is depicted in functional block diagram style, wherein the blocks primarily correspond to functions rather than structure, such functions being one or more of data input, data output, processing, decision-making etc. The safety loop 210 comprises a safety controller 220, which may be implemented in a computer processor or a networked processing resource executing suitable software. In the safety loop 210, there are six safety representatives 230 in a one-to-one or one-to-many relationship with the associated devices 290. Communication with the associated devices 290 is possible over respective links 240. In some embodiments, multiple safety representatives 230 may have a single associated (physical) device 290 or a single group of associated devices 290. In other embodiments, a single safety representative 230 may have multiple associated devices 290. To achieve this, the multiple devices 290 can share same input ports, and the output ports from the devices 290 may be merged at the relevant actuators.

As FIG. 2 illustrates, the safety loop 210 may optionally comprise safety sensors 211 and safety actuators 212. Safety sensors 211 and safety actuators 212 which are stationary and persistently active can be provided directly at the level of the safety loop 210, whereas mobile or occasional sensors and actuators can be more conveniently represented as part of a device 290 in intermittent use.

Each safety representative 230 maintains a virtual representation of the associated device 290, it keeps the virtual representation available for integrity assessment and monitoring by the safety controller, and it performs wireless data synchronization between the virtual representation and the associated device 290. The safety representative 230 can be implemented in different ways. For example, it may be an instance (or object) of a suitable software-defined class. The instantiation may be based on parameter values which reflect the equipment and other properties of the associated device 290 that it represents. The instance may reside in a runtime memory of the safety controller 220 or in the memory of an independent computing device. Alternatively, the safety representative 230 may be implemented as a dedicated component, e.g., in configurable application-specific circuitry, or it may correspond to a record in a nonvolatile memory.

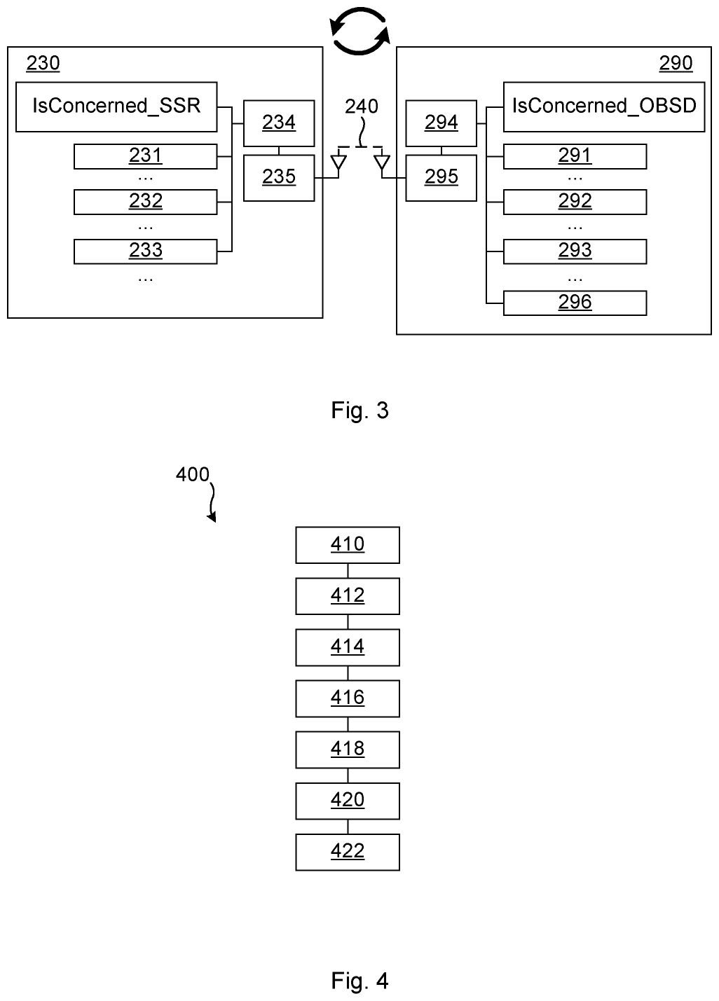

As FIG. 3 shows in greater detail, the virtual representation within the safety representative 230 comprises one or more virtual safety sensors 231, one or more virtual safety actuators 232 and/or one or more virtual safety status 233 (e.g., memory spaces). Optionally, the safety representative 230 includes input and output interfaces as well. The virtual entities correspond to the associated device's 290 safety sensors 291, safety actuators 292, safety status 293 (e.g., communication watchdog timer) and so forth. Each of the sensors 231, actuators 232 and status 233 is characterized at runtime by inbound data, outbound data and current state data. The link 240 may be used for data synchronization (refresh) to ensure, on the one hand, that the virtual components are faithful emulations of the components in the associated device 290. On the other hand, a modification of the safety representative 230 is to be propagated over the link 240 to the associated device 290, which may execute or otherwise act upon it; for example, the associated device 290 may apply propagated data to the output ports of the safety actuators 292. The link 240 may further be used for clock synchronization purposes.

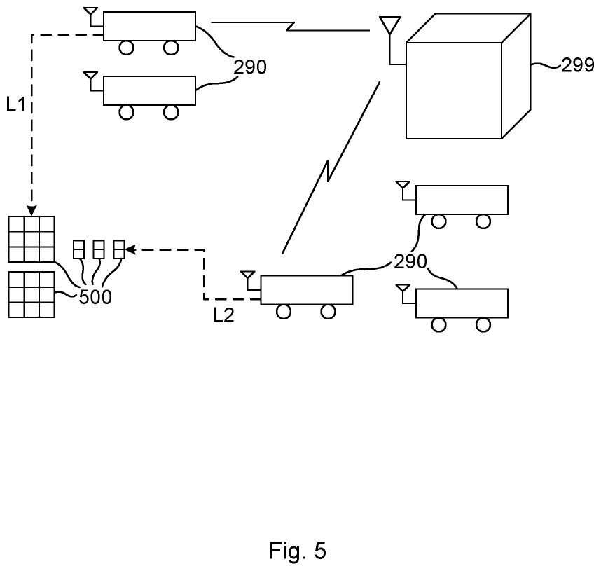

As illustrated by the examples in FIG. 2, the devices 290 in intermittent use can be UAVs, UGVs such as mobile robots, smart wearables, handheld units and similar composite products. An example use case is seen in FIG. 5, where a plurality of mobile robots 290 are coordinated by a fleet management system 299 in wireless communication with the robots 290. For example, the fleet management system 299 may decide to temporarily activate some mobile robots 290 to and participate in handling of materials 500, possibly including following routes L1, L2. After completion of the material handling tasks, the activated mobile robots 290 may enter a standby mode or travel to a parking area. This constitutes an intermittent use.

Within the scope of the present disclosure, however, a device 290 in intermittent use may also be much simpler, such as a smoke sensor, which is a pure sensor that does not necessarily include an actuator. In this case, the associated safety representative 230 does not include any active virtual actuator 232. Another example device 290 in intermittent use is an emergency light or fire-door closer, which is typically controlled in an open-loop fashion. A safety representative 230 associated with these devices may be void of any virtual sensor 231. Similarly, stateless devices might not include any memory for storing a safety status variable.

In the illustrated example embodiment, the device 290 in intermittent use is equipped with a local safety controller 296. The local safety controller 296 is configured to execute at least part of the safety controller's 220 monitoring in accordance with the safety rules, to be described below. A benefit of arranging a local safety controller 296 is to reduce latency and to offload the (centralized) safety controller 220, especially concerning time-critical decision-making. Decision-making to be entrusted to the local safety controller 295 may for example include the enforcement of safety rules related to the device 290 in question.

In the illustrated example embodiment, furthermore, the link 240 is a wireless logical link extending between an interface 235 in the safety representative 230 and an interface 295 in the associated device 290. The link 240 may use cellular, non-cellular or short-range wireless technology, such as 3GPP NR (5G), Wi-Fi™ or Bluetooth™. Between the link 240 and the other components of the safety representative 230, there is provided a safety communication layer 234 and a wireless black channel interface 235. Similarly, the associated device 290 may include a safety communication layer 294 and a wireless black channel interface 295. The safety communication layers may comply with the requirements in [7], and the wireless black channel may comply with the requirements in [8]. In general terms, a black channel can be described as an arbitrary communication channel overlaid with a safety layer that provides resilience to errors such as packet loss, packet repetition, packet corruption, packet resequencing etc. by means of counters, checksums, acknowledgement mechanisms and similar arrangements.

The safety representative 230 and associated device 290 further maintain an activation indicator IsConcerned. The activation indicator can assume at least one positive value (1) and at least one negative value (0) corresponding to use and non-use of the associated device 290, respectively. The activation indicator can be a data structure composed of multiple sub-indicators. The copy of the activation indicator which is maintained in the safety representative 230 is denoted IsConcerned_SSR, and the one in the associated device 290 is denoted IsConcerned_OBSD. In a synchronized state, the values of these variables coincide. As will be explained in detail below, the value of the activation indicator may affect a safety rule that governs the behavior of the safety controller 220, of any local safety controllers 296 and/or the behavior of the safety representative 230.

In some embodiments, the safety controller 220 is configured to assign a value to the activation indicator IsConcerned_SSR of the virtual representation 230 on the basis of data related to the associated device 290 which the safety controller 220 has received from the safety sensors 211. For example, the data may indicate whether the associated device 290 is in its parked position, which could suggest it is not in use (IsConcerned_SSR=0).

In other embodiments, the associated device 290 is configured to assign the value to the activation indicator IsConcerned_SSR of the virtual representation 230. The device 290 may be configured to do so by assigning the value locally to IsConcerned_OBSD and let the running data synchronization process propagate it to the copy IsConcerned_SSR in the virtual representation in the safety representative 230. Alternatively, the device 290 transmits a dedicated communication to the safety representative 230 over the link 240 which causes the new value to be assigned directly to IsConcerned_SSR. The associated device 290 typically has a wealth of different ways to self-determine whether it is in active use or not, either based on internal states or external ones, such as location or orientation. Furthermore, the associated device 290 could select its future active or inactive state on the basis of user input.

In still further embodiments, a supervisory system associated with the device 290 in intermittent use is configured to assign the value to the activation indicator. The supervisory system may be a fleet management system 299 (see FIG. 5) for coordinating mobile robots, which may for example be configured to set IsConcerned_OBSD=1 if the distance from a mobile robot to a predefined activity area is shorter than a predetermined distance. The safety representative 230 reads the new value and synchronizes IsConcerned_SSR so that it agrees with IsConcerned_OBSD.

In the architecture shown in FIGS. 2 and 3, it is a basic responsibility of the safety controller 220 and any local safety controllers 296 to monitor the safety sensors 211, 231, 291 and perform decision-making on the basis of the data they provide. If a safety controller 220, 296 detects a safety event, it may cause the safety actuators 212, 232 to respond to it in accordance with safety rules. As mentioned, a modification of a virtual safety actuator 232 will be propagated to a safety actuator 292 of the associated device 290 as a result of data synchronization and thus acted upon. This response may be triggered by data provided by a virtual safety sensor 231 belonging to the same associated device 290 or belonging to a different device 290; the data may even originate from one of the static safety sensors 211 if such are present. Conversely, a static safety actuator 212 may respond to a safety event triggered by data from a virtual safety sensor 231. In an example implementation, the safety controllers 220, 296 are configured to scan the (static) sensors 211 and actuators 212 in the control loop 210 as well as the sensors 231 and actuators 232 in the safety representatives 230. Within the scanning, the safety controllers 220, 296 read the status and inputs, produce the outputs according to the control logic (e.g., safety rules) and write the outputs to the components concerned.

Integrity assessment constitutes another responsibility of the safety controller(s) 220, 296. For this purpose, the central safety controller 220 may perform a test procedure to verify, on a periodic or event-triggered basis, that the safety network 200 is complete and functional. The completeness may be checked against a current configuration (e.g., entered by an operator or system administrator), which specifies components that the safety network 200 shall nominally include. The test procedure may include communicating with the safety sensors 211, 231 and safety actuators 212, 232 and/or verifying that they transmit sensor data and/or receive control data as specified. From the point of view of the local safety controller 296, the integrity assessment is typically limited to the associated device 290, and the completeness check may refer to a local configuration specifying the safety-related components of that device 290. The local safety controller 296 may report an outcome of the integrity assessment to the central safety controller 220. It is particularly relevant to report a non-favorable outcome, which may suggest an unwanted change in topology and may trigger a change to safe state.

In some embodiments, the responsibility for monitoring is shared between the central safety controller 220 and the local safety controllers 296, while integrity assessment is the exclusive responsibility of the central safety controller 220. According to one possible configuration, the local safety controller 296 monitors safety rules involving the possible use of safety actuators 292 in the associated device, whereas the (central) safety controller 220 monitors safety rules involving possible triggering of safety actuators 212 and/or triggering of more than one output ports of the safety actuators 292. This is to say, the safety controller 220 may influence the behavior of more than one device 290.

The positive (1) or negative (0) value of the activation indicator IsConcerned may affect a safety rule that governs the behavior of different components of the safety network 200. Table 1 provides representative examples, which may be used individually or in combinations.

TABLE 1
Safety rules

| | IsConcerned = 1 | IsConcerned = 0 |
|---|---|---|
| 1 | The safety controller 220 shall | The safety controller 220 shall not |
| | monitor the virtual safety sensor 231 | monitor the virtual safety sensor 231 |
| | of the virtual representation and | and virtual safety actuator 232 of the |
| | cause the virtual safety actuator 232 | virtual representation. |
| | to respond to any detected safety | |
| | events. | |
| 2 | The safety controller 220 shall | The safety controller 220 shall not |
| | monitor the virtual safety sensor 231 | monitor the virtual safety sensor 231 |
| | of the virtual representation and | and virtual safety actuator 232 of the |
| | cause the virtual safety actuator 232 | virtual representation, but the virtual |
| | to respond to any detected safety | safety sensor 231 and virtual safety |
| | events, and the safety controller 220 | actuator 232 of the virtual |
| | shall respond to a detected safety | representation shall remain included |
| | event in one virtual representation | in the safety controller's 220 |
| | with effect on that virtual | integrity assessment. |
| | representation only (e.g., by | |
| | ordering a safe state). | |
| 3 | The safety representative 230 shall | The safety representative 230 shall |
| | perform data synchronization | maintain the virtual representation to |
| | between the virtual representation | enable the safety controller's 220 |
| | and the associated device 290. | integrity assessment. |
| 4 | The associated device 290 shall | All risk-inducing functionalities of the |
| | execute any data related to the | associated device 290, e.g., |
| | virtual safety actuators 232 which it | expressed as a predefined set of |
| | receives as a result of the data | functionalities, shall be disabled. A |
| | synchronization (data refresh). | local safety controller 296, if |
| | | present, reacts to local information |
| | | from the safety sensors 291 and |
| | | trigger safety actuators 292 as |
| | | needed based on local safety rules. |
| 5 | A communication watchdog timer | A communication watchdog timer |
| | 293 of the associated device 290 | 293 of the associated device 290 |
| | shall have a default value. | shall have an increased value. |
| 6 | The clock synchronization shall | The clock synchronization shall |
| | have a default tolerance. | have an increased tolerance. |

Here, Rules 1 and 2 affect the safety controller 220 or the local safety controller 296, to the extent it executes some of the safety controller's 220 monitoring. Rule 3 affects the safety representative 230. Rules 4 and 5 affect the device 290 in intermittent use. Rule 6 primarily affects the communication interfaces 235, 295 in the safety representative 230 and the associated device 290. As announced initially, the variable definition of safety rules, as concretized by the examples according to Table 1, allows the safety network 200 to be adapted in view of the current usage conditions, without a strong need to reconfigure the network 200 at runtime and without having to sacrifice the integrity assessment.

With regard to Rule 5 specifically, some remarks about the values of the communication watchdog timer at the device 290 are of order. For example, if the openSAFETY protocol [9] is applied as the safety communication layer 234, the default value of the Node Guarding Time defined by the SNMT_ResetGuarding_U32 is 10 s. The value can be set as large as 0xFFFFFFFF, which corresponds to about 400 000 s or 100 hours. When the device 290 is inactive, the use of an increased timer value of this magnitude can help reduce unnecessary network load. It may also help reduce the probability of false triggering of the safe state as a result of temporarily poor wireless connectivity.

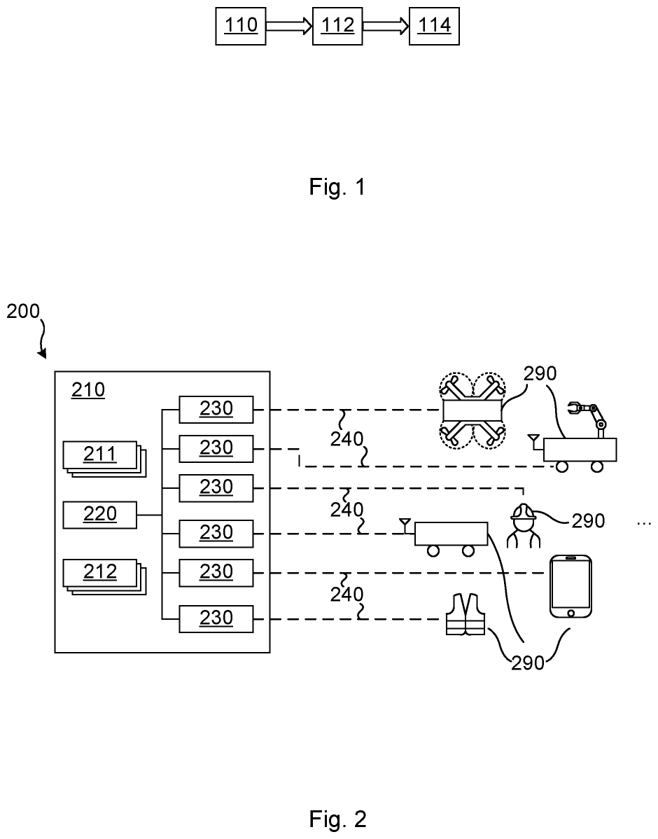

In one embodiment, the safety network 200 is operable to implement at least one validation interface (not shown). When present, the validation interface facilitates the verification and/or validation of a safety function (cf. FIG. 1) in an associated device 290 in intermittent use. For this purpose, the validation interface applies test signals in the associated device 290 and monitors status or measurement signals. A test procedure or protocol may be executed allowing, as one of its outcomes, a conclusion that the associated device 290 meets a corresponding technical standard, norm, regulation or specification. A safety network 200 according to this embodiment is scalable since verification and validation can be performed without occupying the runtime resources.

Some of the above discussion is summarized by the flowchart in FIG. 4, which represents a method 400 of operating the safety network 200 shown in FIG. 2 or a similar safety network in such manner as to support devices 290 in intermittent use.

The method 400 comprises a repeated assessment 410 of the integrity of the safety network 200. The method 400 further comprises a repeated monitoring 412 of a plurality of safety sensors 211, 231 in order to detect safety events. The method 400 further comprises responding 414 to any detected safety events by means of safety actuators 212, 232 and in accordance with safety rules. Still further, the safety network 200 is made 416 available for verification and/or validation as a safety loop.

According to embodiments of the invention, the method 400 further comprises maintaining 418 a virtual representation of an associated one of said devices 290 in intermittent use and making 420 the virtual representation available for said integrity assessment and monitoring steps 410, 412. The method 400 further includes wireless data synchronization 422 between the virtual representation and the associated device 290. This virtual representation may have the properties of the safety representative's 230 virtual representation described above. In particular, it includes an at least two-valued activation indicator IsConcerned, which determines a safety rule for said monitoring 412 and/or said data synchronization 422.

The aspects of the present disclosure have mainly been described above with reference to a few embodiments. However, as is readily appreciated by a person skilled in the art, other embodiments than the ones disclosed above are equally possible within the scope of the invention, as defined by the appended patent claims.

1. A safety network for supporting one or more devices in intermittent use, the safety network being susceptible of verification and/or validation as a safety loop and comprising a safety controller configured to:
assess the integrity of the safety network, and
monitor safety sensors and cause safety actuators to respond to any detected safety events in accordance with safety rules,
wherein the safety network implements one or more safety representatives, each configured to
maintain a virtual representation of an associated device in intermittent use, the virtual representation including at least one virtual safety sensor and/or virtual safety actuator,
make the virtual representation available for integrity assessment and monitoring by the safety controller, and
perform wireless data synchronization between the virtual representation and the associated device,
wherein the virtual representation further includes an at least two-valued activation indicator (IsConcerned), which determines a safety rule for the safety controller's monitoring and/or for the safety representative's data synchronization.

2. The safety network of claim 1, wherein the safety controller is configured to assign a value to the activation indicator (IsConcerned) of the virtual representation on the basis of data related to the associated device from the safety sensors.

3. The safety network of claim 1, wherein the associated device is configured to assign a value to the activation indicator (IsConcerned) of the virtual representation.

4. The safety network of claim 1, wherein a supervisory system associated with the device in intermittent use is configured to assign a value to the activation indicator (IsConcerned) of the virtual representation.

5. The safety network of claim 1, wherein a positive value of the activation indicator (IsConcerned) determines a safety rule stipulating that the safety controller shall monitor the virtual safety sensor of the virtual representation and cause the virtual safety actuator to respond to any detected safety events.

6. The safety network of claim 5, wherein a positive value of the activation indicator (IsConcerned) determines a safety rule stipulating that the safety controller shall respond to a detected safety event in one virtual representation with effect on that virtual representation only.

7. The safety network of claim 1, wherein a negative value of the activation indicator (IsConcerned) determines a safety rule stipulating that the virtual safety sensor and virtual safety actuator of the virtual representation shall be excluded from the safety controller's monitoring.

8. The safety network of claim 7, wherein the virtual safety sensor and virtual safety actuator of the virtual representation shall remain included in the safety controller's integrity assessment under said safety rule.

9. The safety network of claim 1, wherein a positive value of the activation indicator (IsConcerned) determines a safety rule stipulating that the safety representative shall perform data synchronization between the virtual representation and the associated device.

10. The safety network of claim 1, wherein a negative value of the activation indicator (IsConcerned) determines a safety rule stipulating that the safety representative shall maintain the virtual representation to enable the safety controller's integrity assessment.

11. The safety network of claim 1, wherein a positive value of the activation indicator (IsConcerned) determines a safety rule stipulating that the associated device shall execute any data related to the virtual safety actuators which it receives as a result of the data synchronization.

12. The safety network of claim 1, wherein a negative value of the activation indicator (IsConcerned) determines a safety rule stipulating that a predetermined set of risk-inducing functionalities of the associated device shall be disabled.

13. The safety network of claim 1, wherein a negative value of the activation indicator (IsConcerned) determines a safety rule stipulating that a communication watchdog timer of the associated device shall be increased.

14. The safety network of claim 1, wherein:
each safety representative is further configured to perform clock synchronization between the virtual representation and the associated device; and
a negative value of the activation indicator (IsConcerned) determines a safety rule stipulating that a tolerance of the clock synchronization shall be increased.

15. The safety network of claim 1, which implements multiple safety representatives configured to maintain respective virtual representations of a single associated device in intermittent use or of a group of such devices.

16. The safety network of claim 1, wherein the safety network is operable to implement at least one validation interface to facilitate verification and/or validation of a safety function in an associated device in intermittent use, each validation interface configured to apply test signals in the associated device and monitor status or measurement signals.

17. The safety network of claim 1, wherein the associated device comprises a local safety controller configured to execute at least part of the safety controller's monitoring in accordance with the safety rules.

18. The safety network of claim 1, further comprising:
a plurality of safety sensors and safety actuators.

19. A method of operating a safety network for supporting one or more devices in intermittent use, the method comprising:
repeatedly assessing the integrity of the safety network;
repeatedly monitoring a plurality of safety sensors to detect safety events;
responding to any detected safety events using a plurality of safety actuators and in accordance with safety rules; and
making the safety network available for verification and/or validation as a safety loop,
the method characterized by
maintaining a virtual representation of an associated one of said devices in intermittent use, the virtual representation including at least one virtual safety sensor and/or at least one virtual safety actuator;
making the virtual representation available for said integrity assessment and monitoring; and
performing wireless data synchronization between the virtual representation and the associated device,
wherein the virtual representation further includes an at least two-valued activation indicator (IsConcerned), which determines a safety rule for said monitoring and/or said data synchronization.

20. A safety representative implemented in a safety network for supporting one or more devices in intermittent use,
the safety representative comprising:
a virtual representation of an associated one of said devices in intermittent use, the virtual representation including at least one virtual safety sensor and/or virtual safety actuator,
the virtual representation available for integrity assessment and monitoring by a safety controller of the safety network, and
wireless data synchronization between the virtual representation and the associated device,
wherein the safety representative is further configured to maintain, in the virtual representation, and at least two-valued activation indicator (IsConcerned), which determines a safety rule the for the safety representative's data synchronization.
